(19) United States
(12) Patent Application Publication
(10) Pub. No.: US 2025/0060020 A1
(43) Pub. Date: Feb. 20, 2025

(54) SYSTEM AND METHOD FOR VIBRATION SUPPRESSION OF STAR SIMULATION SYSTEM BY MEANS OF LASER INTERFERENCE DETECTION

(71) Applicant: CAS NANJING ASTRONOMICAL INSTRUMENTS CO., LTD, Jiangsu (CN)

(72) Inventors: Jinpeng LI, Jiangsu (CN); Xinrui WANG, Jiangsu (CN); Yongxing YANG, Jiangsu (CN); Saiya WANG, Jiangsu (CN); Yong MA, Jiangsu (CN); Jingyuan ZHANG, Jiangsu (CN); Yu HAN, Jiangsu (CN)

(21) Appl. No.: 18/725,064

(22) PCT Filed: Oct. 20, 2022
(86) PCT No.: PCT/CN2022/126303

§ 371 Date: Jun. 27, 2024

(30) Foreign Application Priority Data
Dec. 27, 2021 (CN) 202111611406.X

(51) Int. Cl. F16F 15/00; G01S 3/786

(52) U.S. Cl. CPC F16F 15/002; G01S 3/7867

(57) ABSTRACT

The present invention discloses a vibration suppression system and method for a star simulation system using laser interference detection. The system includes a laser light source, a first beam splitter, a collimator set, a second beam splitter, a mirror, a detection convergent mirror assembly, a CCD detector, a computer control system, a jitter compensating mirror and a flat splitter; the optical path of the whole system includes a reference optical path and a detection compensating signal optical path. The reference optical path and the detection compensating signal optical path converge at the same time on the CCD detector to constitute a vibration detection interference optical path, and the computer control system performs feedback compensation according to the interferogram intensity change formed by the vibration detection interference optical path. Both the CCD detector and the jitter compensating mirror are connected to the computer control system. The present invention improves the accuracy of spacecraft attitude tracking correction by adding a laser light source and a second beam splitter so that both star simulation imaging and optical path jitter compensation correction can be performed.

### TECHNICAL FIELD

The present invention relates to the technical field of spacecraft calibration, and in particular to a vibration suppression system and method for a star simulation system using laser interference detection.

### BACKGROUND TECHNOLOGY

The star tracker is the most accurate space attitude optical sensor to determine the position of spacecraft, which has been widely used in the field of aerospace. The star tracker is essentially a camera, which is connected to the satellite airborne computer to obtain star images in its field of view. The fixed star can be identified from the observed star images, which can be used as a reference to calculate the flight position deviation and attitude deviation of spacecraft in real-time. Then the spacecraft can be corrected according to the deviation data provided by the star tracker.

As an important part of measurement and ground calibration of star tracker in laboratory environment, the star simulator can strictly simulate the characteristics of brightness, opening angle and distance of stars in the real starry sky, providing the recognition targets for the star tracker. Due to the difference between the laboratory development environment and the space orbit operation environment, there are errors in the in-orbit operation of the star tracker. The star simulator is an environmental simulation technology to calibrate the errors. The performance of the star simulator is related to the external environment disturbance. In order to improve the accuracy of ground calibration, vibration compensation and correction needs to be carried out for the optical path of star simulator. The vibration compensation correction system and the star simulation system are separate in traditional star simulator. The compensation and correction system should be carried out before the star graph simulation. The operation process is complicated and there would be larger error.

### SUMMARY OF THE INVENTION

In view of the above-mentioned problems existing in the prior technology, the present invention provides a vibration suppression system and method for star simulation system using laser interference detection, which can achieve both the jitter correction of an optical path via a jitter compensating mirror and star simulation.

In order to achieve the above objective, the present invention adopts the following technical solution:
a vibration suppression system for star simulation system using laser interference detection, including a laser source, a first beam splitter, imaging lens set, collimator set, a second beam splitter, a mirror, detection convergent lens set, a CCD detector, a computer control system, a jitter compensating mirror and a flat splitter, a first star point reticle, a second star point reticle, a first light source, a second light source; the optical path of the whole system including a reference optical path and a detection compensating signal optical path, wherein:
the reference optical path: the light emitted by the laser light source reaches the collimator set via the first beam splitter to emit first parallel light beams which reach the mirror via the second beam splitter, and are reflected by the mirror to form second light beams which reach the detection convergent lens set, and the emitted light converges on the CCD detector to form a reference optical path;
the detection compensating signal optical path: the parallel first light beams transmit the second beam splitter to form third light beams; the third light beams are reflected by the jitter compensating mirror and propagate to the flat splitter; the reflected light beams reflected by the flat splitter are reflected by the jitter compensating mirror to the second beam splitter to form fourth light beams; the fourth light beams propagate to the detection convergent mirror assembly and converge on the CCD detector to form a detection compensating signal optical path;
the CCD detector and the jitter compensating mirror are both coupled to a computer control system; the reference optical path and the detection compensating signal optical path converge at the same time on the CCD detector to constitute a vibration detection interference optical path, and the computer control system performs feedback compensation according to the interferogram intensity changes formed by the vibration detection interference optical path.

Further, the system includes a first light source, a first star point reticle, a second light source, a second star point reticle, and a star tracker, wherein a fifth light beam formed by the first light source illuminating the first star point reticle and a sixth light beam formed by the second light source illuminating the second star point reticle form a stable star simulated graph at the target surface of the star tracker through an optical system corrected by a jitter compensating mirror.

Further, the first beam splitter includes a first light splitting surface inside the first beam splitter and a second light splitting surface at the bottom of the first beam splitter, and the second beam splitter includes a light splitting surface inside the second beam splitter.

Further, in the reference optical path, the light emitted by the laser light source is transmitted through the first light splitting surface to reach the second light splitting surface for total reflection to the first light splitting surface and is reflected by the first light splitting surface of the first beam splitter to the collimator assembly to be emitted as parallel first beams; the first light beams reflected by the light splitting surface of the second beam splitter to reach the mirror are reflected by the mirror to form the second light beams to reach the detection convergent mirror assembly; and the emitted light is converged on the CCD detector to constitute the reference optical path.

Further, in the detection compensating signal optical path, the parallel first light beams transmit the light splitting surface of the second beam splitter to form third light beams; the third light beams are reflected by the jitter compensating mirror and propagate to the flat splitter; the reflected light beams reflected by the flat splitter are reflected by the jitter compensating mirror to the second beam splitter to form fourth light beams by the reflection of the light splitting surface of the second beam splitter; and the fourth light beams propagate to the detection convergent mirror assembly and converge on the CCD detector to form a detection compensating signal optical path.

Further, the system further includes imaging lens set arranged between the laser light source and the first beam splitter.

Further, a first light splitting surface of the first beam splitter is coated with a semi-transparent and semi-reflective film for the light emitted by the laser light source, and a second light splitting surface of the first beam splitter is coated with a fully reflective film for the light emitted by the laser light source; the light splitting surface of the second beam splitter is coated with a semi-transparent and semi-reflective film for the light emitted by a laser light source; the mirror, a jitter compensating mirror and a flat splitter are coated with a fully reflective film for the light emitted by the laser light source; a first light splitting surface of the first beam splitter is coated with a fully transparent film for the light emitted by a first light source, and is coated with fully reflective films for the light emitted by a second light source; the light splitting surface of the second beam splitter is coated with a fully transparent film for the light emitted by the first light source and the second light source; and the flat splitter is coated with a fully transparent film for the light emitted by the first light source and the second light source.

Further, the aperture of the flat splitter is smaller than the light transmission aperture of the star tracker. On the one hand, the flat splitter reflects the vibration compensating signal light, on the other hand, the light emitted by the first light source and the second light source transmits and propagates from both sides of the flat splitter to the star tracker.

A vibration suppression method for star simulation system using laser interference detection, wherein interferogram intensity changes formed by the two optical paths of the reference optical path and the detection compensating signal optical path via CCD detector is measured, an external vibration amount is calculated via computer control system, the jitter compensating mirror is controlled to perform feedback compensation, and compensation correction is simultaneously performed on the vibration caused by the environment simulation system on the basis of the star graph simulation to cancel the jitter effect of the light beams due to the vibration of the lens assembly; the fifth light beams formed by the first light source illuminating the first star point reticle and the sixth light beams formed by the second light source illuminating the second star point reticle pass through the optical system corrected by the jitter compensating mirror to form a stable star simulated graph at the target surface of the star tracker.

The significant advantages of the present invention over the prior technology are: the jitter compensation technology and star imaging technology for the traditional star simulator are separated, which makes the system too complex and star imaging operation too cumbersome. The system and method improve the accuracy of spacecraft attitude tracking correction by adding a laser light source and a second beam splitter so that both star simulation imaging and optical path jitter compensation correction can be performed.

### BRIEF DESCRIPTION OF THE DRAWINGS

FIG. 1 is a schematic diagram showing an overall optical path of the system;

FIG. 2 is a schematic diagram showing a reference optical path; and

FIG. 3 is a schematic diagram showing a detection compensating signal optical path.

### DETAILED DESCRIPTION OF THE INVENTION

The following detailed description of the embodiments and the working principles of the present invention will be made with reference to the accompanying drawings.

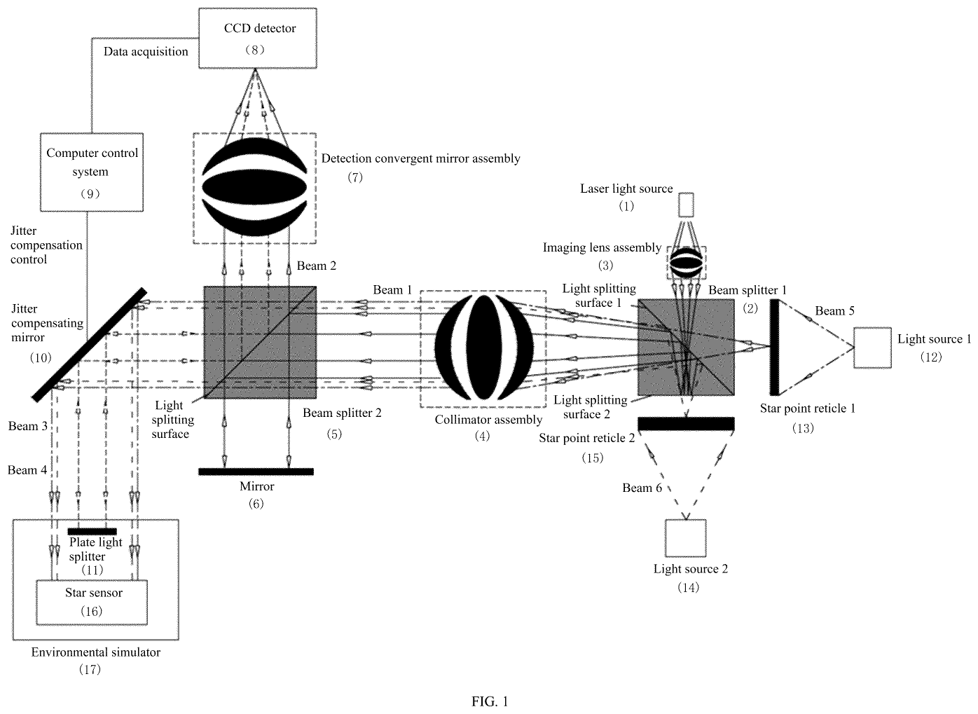

The present embodiment adopts the vibration suppression system for star simulation system using laser interference detection, as shown in FIG. 1, this system integrates an interference system primarily in star simulator system. The system mainly includes a laser light source 1, a first beam splitter 2, imaging lens set 3, collimator set 4, a second beam splitter 5, a mirror 6, detection convergent mirror set 7, a CCD detector 8, a computer control system 9, a jitter compensating mirror 10, a flat splitter 11, a first light source 12, a first star point reticle 13, a second light source 14, a second star point reticle 15, and a star tracker 16.

The light splitting surface 1 of the first beam splitter is coated with a semi-transparent and semi-reflective film for the light emitted by the laser, and the light splitting surface 2 of the first beam splitter is coated with a fully reflective film for the light emitted by the laser; the light splitting surface of the second beam splitter is coated with a semi-transparent and semi-reflective film for the light emitted by the laser; a mirror, a jitter compensating mirror and a flat splitter are coated with fully reflective films for the light emitted by the laser; the first beam splitter is coated with a fully transparent film for the light emitted by the light source 1, and is coated with a fully reflective film for the light emitted by the light source 2; the second beam splitter is coated with a fully transparent film for the light emitted by the light source 1 and the light source 2, and the flat splitter is coated with a fully transparent film for the light emitted by the light source 1 and the light source 2; through this coating and optical path design, the star simulation system can be compensated and corrected on the basis of star graph simulation.

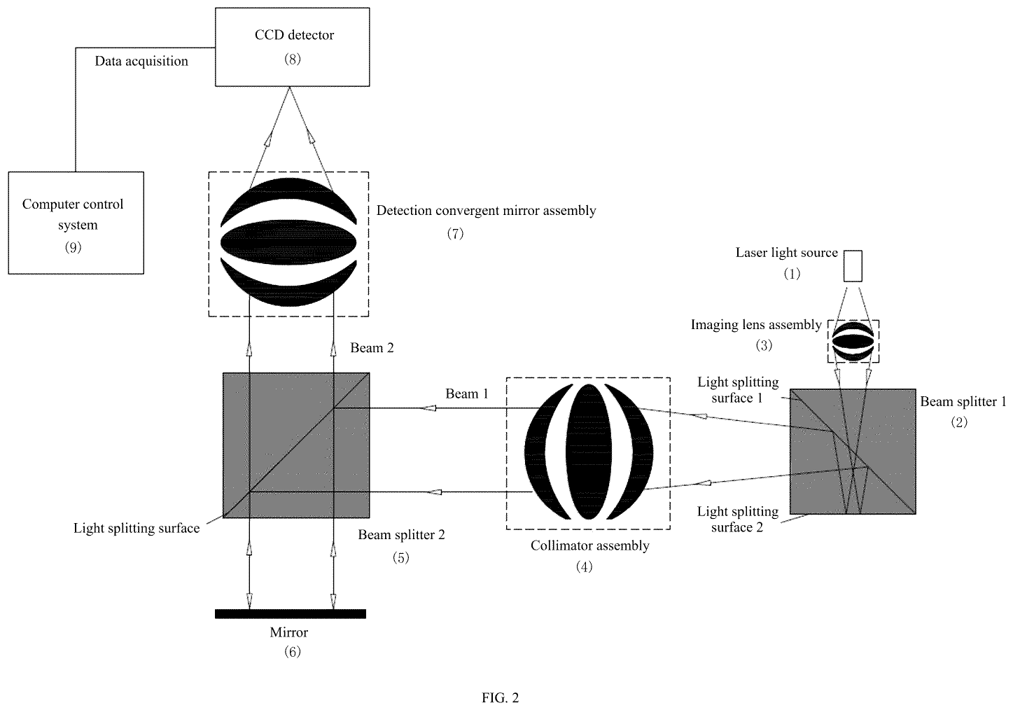

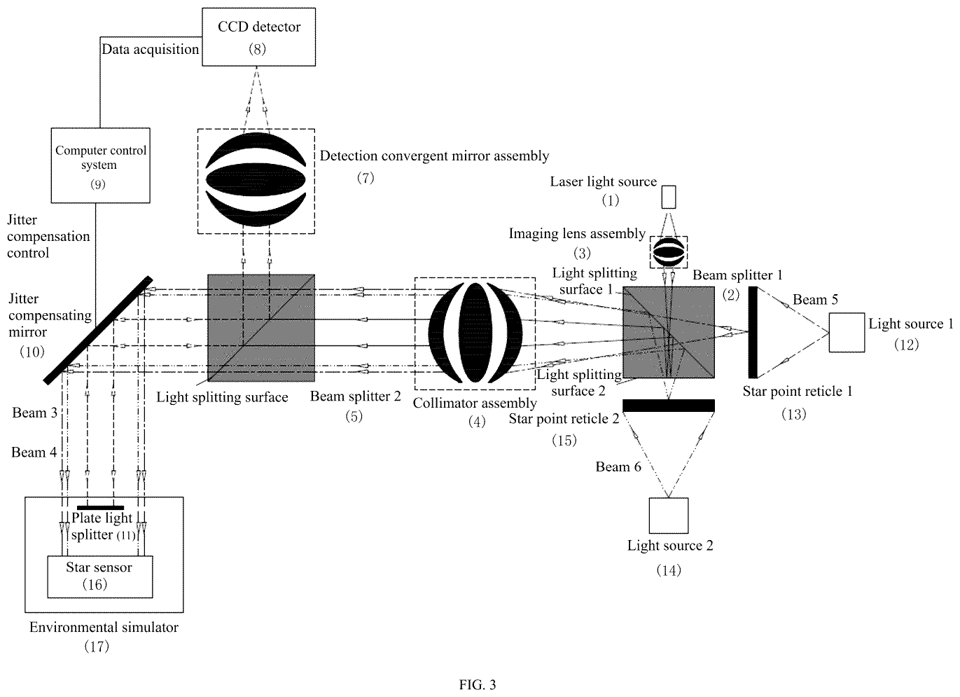

The optical path of the whole system can be divided into two parts: a reference optical path and a detection compensating signal optical path respectively. The reference optical path and the detection compensating signal optical path are as follows:
as shown in FIG. 2, the reference optical path: the light emitted by the laser light source is transmitted through the first beam splitter to reach the light splitting surface 2 of the first beam splitter for total reflection to reach the light splitting surface 1 of the first beam splitter, and is reflected to the collimator set to be emitted as parallel first light beams; the first light beams reflected by the second beam splitter to reach the mirror are reflected by the mirror to form second light beams to reach the detection convergent mirror assembly; the emitted light is converged on the CCD detector to constitute a reference optical path;
the detection compensating signal optical path is as shown in FIG. 3: the parallel first light beams transmit the second beam splitter to form third light beams; the third light beams are reflected by the jitter compensating mirror and propagate to the flat splitter; the reflected light beams reflected by the flat splitter are reflected by the jitter compensating mirror to the second beam splitter to form fourth light beams; the fourth light beams propagate to the detection convergent mirror assembly and converge on the CCD detector to form a detection compensating signal optical path. The reference optical path and the detection compensating signal optical path converge at the same time on the CCD detector 8 to constitute a vibration detection interference optical path, and the feedback compensation is performed according to the interferogram intensity changes formed by the vibration detection interference optical path.

In the present embodiment, the aperture of the flat mirror aperture is smaller than the light transmission aperture of the star tracker, and by coating on the flat splitter, the vibration compensating signal light can be reflected, and the light emitted by the light source 1 and the light source 2 can be transmitted and propagated from both sides to the star tracker for performing the two functions of star imaging.

The vibration suppression method for star simulation system according to the present embodiment includes: the interferogram intensity changes formed by the two optical paths of the reference optical path and the detection compensating signal optical path is measured by CCD detector 8, the external vibration amount is calculated by computer control system, and the jitter compensating mirror is controlled to perform feedback compensation to cancel the jitter effect of the light beams due to the vibration of the lens assembly. So that the fifth light beam and the sixth light beam formed by the first star point reticle 13 illuminated by the first light source 12 and the second star point reticle 15 illuminated by the second light source 14 form a stable star simulated graph at the target surface of the star tracker 16 through the optical system corrected by the jitter compensating mirror 10. The method can compensate and correct the vibration caused by the environment simulation system based on the star graph simulation.

The present embodiment is a vibration suppression system and method for star simulation system using laser interference detection. The whole system is placed on the same optical platform to isolate the ground vibration, there is no vibration between the detection compensation optical path and the star simulation optical path. The effect of the external vibration on the two optical paths is identical. The interference reference optical path can detect the external vibration and directly measure the effect of the optical element jitter on the optical beams due to the external environment disturbance in the calibration process to control the jitter compensating mirror to perform targeted compensation and improve the accuracy of the ground calibration of the star simulator; and while the device performs jitter compensation, the light source 1 and the light source 2 directly illuminate the first star point reticle and the second star point reticle to perform star imaging on the target surface of the star tracker.

In view of the fact that the current star simulator devices do not have jitter compensation technology and multi-field, multi-function star imaging device system, the present embodiment proposes a vibration suppression system for star simulation system using laser interference detection. The light emitted by the laser light source transmits the first beam splitter, propagates to the second beam splitter via total reflection of the second light splitting surface of the first beam splitter, and then reflects and transmits same via the second beam splitter to form two optical paths, wherein the second light beams reflected by the mirror serves as a reference optical path, and the fourth light beams reflected by the flat splitter and the jitter compensating mirror serves as the detection compensating signal light; the CCD detector detects the two optical paths simultaneously. According to the interferogram intensity changes formed by the two optical paths, the external vibration amount is calculated via computer control system, and the jitter compensating mirror is controlled to perform feedback compensation, thus further counteracting the effect of the vibration of the light beams due to the vibration of the lens assembly. Thus, the optical path formed by the star point reticle 1 and the star point reticle 2 illuminated by the light source and the optical system after jitter correction can form a star image with better imaging quality on the target surface of the star tracker.

What has not been described in detail in the description of the present invention is well known to a person skilled in the art.

In summary, the present invention provides a vibration suppression system and method for star simulation system using laser interference detection. The main components of the device include a laser light source, a beam splitter, a star point reticle, imaging lens set, collimator set, a mirror, a jitter compensating mirror, a flat splitter, detection convergent mirror assembly, a CCD detector, a first light source, a second light source, a star tracker and a computer control system. According to the method, based on the star graph simulation, jitter compensation correction can be performed for the star simulation system at the same time; the light emitted by the laser light source is transmitted to the collimator set via the first beam splitter, and the parallel first light beams emitted are reflected and transmitted by the second beam splitter to be divided into a reference light and a detection compensating signal light; the reference light and the detection compensating signal light converge to the CCD to form interference fringes; according to the interferogram intensity changes formed by the two optical paths, the external vibration amount is calculated by computer control system, and the jitter compensating mirror is controlled to perform feedback compensation, so that the optical path formed by the star point reticle 1 and the star point reticle 2 illuminated by the light source can form a stable star graph on the target surface of the star tracker via the optical system after jitter correction.

The above description is of preferred embodiments of the present invention and is not intended to limit the present invention. Any modifications, equivalent substitutions, and improvements made within the spirit and principles of the present invention are included within the scope of the present invention.

1. A vibration suppression system for star simulation system using laser interference detection, comprising a laser light source, a first beam splitter, collimator set, a second beam splitter, a mirror, a detection convergent mirror assembly, a CCD detector, a computer control system, a jitter compensating mirror and a flat splitter; the optical path of the whole system comprises a reference optical path and a detection compensating signal optical path, wherein:
the reference optical path: the light emitted by the laser light source reaches the collimator set via the first beam splitter to emit parallel first light beams which reach the mirror via the second beam splitter, and are reflected by the mirror to form second light beams which reach the detection convergent mirror assembly, and the emitted light converges on the CCD detector to form a reference optical path;
the detection compensating signal optical path: the parallel first light beams transmit the second beam splitter to form third light beams; the third light beams are reflected by the jitter compensating mirror and propagate to the flat splitter; the reflected light beams reflected by the flat splitter are reflected by the jitter compensating mirror to the second beam splitter to form fourth light beams; the fourth light beams propagate to the detection convergent mirror assembly and converge on the CCD detector to form a detection compensating signal optical path;
the CCD detector and the jitter compensating mirror are both coupled to computer control system; the reference optical path and the detection compensating signal optical path converge at the same time on the CCD detector to constitute a vibration detection interference optical path, and the computer control system performs feedback compensation according to interferogram intensity changes formed by the vibration detection interference optical path.

2. The vibration suppression system for star simulation system using laser interference detection according to claim 1, further comprising a first light source, a first star point reticle, a second light source, a second star point reticle, and a star tracker, wherein the fifth light beams formed by the first light source illuminating the first star point reticle and the sixth light beam formed by the second light source illuminating the second star point reticle form a stable star simulated graph on the target surface of the star tracker through the optical system corrected by jitter compensating mirror.

3. The vibration suppression system for star simulation system using laser interference detection according to claim 1, wherein the first beam splitter comprises a first light splitting surface inside the first beam splitter and a second light splitting surface at the bottom of the first beam splitter, and the second beam splitter includes a light splitting surface inside the second beam splitter.

4. The vibration suppression system for star simulation system using laser interference detection according to claim 3, wherein in the reference optical path, the light emitted by the laser light source is transmitted through the first light splitting surface to reach the second light splitting surface for total reflection to the first light splitting surface and is reflected by the first light splitting surface of the first beam splitter to the collimator set to be emitted as parallel first light beams, and the first light beams reflected by the light splitting surface of the second beam splitter to reach the mirror are reflected by the mirror to form the second light beams to reach the detection convergent mirror assembly, and the emitted light is converged on the CCD detector to constitute the reference optical path.

5. The vibration suppression system for star simulation system using laser interference detection according to claim 3, wherein in the detection compensating signal optical path, the parallel first light beams transmit the light splitting surface of the second beam splitter to form third light beams; the third light beams are reflected by the jitter compensating mirror and propagate to the flat splitter; the reflected light beams reflected by the flat splitter are reflected by the jitter compensating mirror to the second beam splitter to form the fourth light beams by the reflection of the light splitting surface of the second beam splitter; and the fourth light beams propagate to the detection convergent mirror assembly and converge on the CCD detector to form a detection compensating signal optical path.

6. The vibration suppression system for star simulation system using laser interference detection according to claim 1, further comprising an imaging lens assembly arranged between the laser light source and the first beam splitter.

7. The vibration suppression system for star simulation system using laser interference detection according to claim 3, wherein the first light splitting surface of the first beam splitter is coated with a semi-transparent and semi-reflective film for the light emitted by the laser light source, and the second light splitting surface of the first beam splitter is coated with a fully reflective film for the light emitted by the laser light source; the light splitting surface of the second beam splitter is coated with a semi-transparent and semi-reflective film for the light emitted by the laser light source; the mirror, the jitter compensating mirror and the flat splitter are coated with fully reflective films for the light emitted by the laser light source; the first light splitting surface of the first beam splitter is coated with a fully transparent film for the light emitted by the first light source, and is coated with a fully reflective film for the light emitted by the second light source; the light splitting surface of the second beam splitter is coated with a fully transparent film for the light emitted by the first light source and the second light source; and the flat splitter is coated with a fully transparent film for the light emitted by the first light source and the second light source.

8. The vibration suppression system for star simulation system using laser interference detection according to claim 2, wherein the aperture of the flat splitter is smaller than the light transmission aperture of the star tracker, on the one hand, the flat splitter reflects the vibration compensating signal light, on the other hand, the light emitted by the first light source and the second light source transmits and propagates from both sides of the flat splitter to the star tracker.

9. A vibration suppression method for star simulation system using laser interference detection, wherein the interferogram intensity change formed by the two optical paths of the reference optical path and the detection compensating signal optical path according to claim 1 via the CCD detector is measured, the external vibration amount is calculated via the computer control system, the jitter compensating mirror is controlled to perform feedback compensation, and compensation correction is simultaneously performed on the vibration caused by the environment simulation system on the basis of the star graph simulation to cancel the jitter effect of the light beams due to the vibration of the lens assembly; the fifth light beams formed by the first light source illuminating the first star point reticle and the sixth light beams formed by the second light source illuminating the second star point reticle pass through the optical system corrected by the jitter compensating mirror to form a stable star simulated graph on the target surface of the star tracker.
